(19) United States
(12) Patent Application Publication
(10) Pub. No.: US 2006/0176333 A1
(43) Pub. Date: Aug. 10, 2006

(54) Liquid ejecting apparatus and liquid suction device of the same

(75) Inventors: Kaoru Momose, Nagano (JP); Shiro Kobayashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/331,137

(22) Filed: Jan. 13, 2006

(30) Foreign Application Priority Data
Jan. 13, 2005 (JP) P2005-006022

(51) Int. Cl. B41J 2/165

(52) U.S. Cl. 347/30

(57) ABSTRACT

A liquid ejecting apparatus is operable to eject liquid onto a medium. A head is inclined with respect to a horizontal line, and includes nozzles from which the liquid is ejected to the medium. A liquid suction device includes a main body operable to seal the nozzles, a suction unit operable to suction the interior of the main body so as to suction the liquid from the nozzles, a first suction port provided at an upper portion of the main body and connected to the suction unit, and a second suction port provided at a lower portion of the main body and connected to the suction unit.

### BACKGROUND OF THE INVENTION

The present invention relates to a liquid ejecting apparatus having a liquid suction device for suctioning liquid from nozzles of a head, which is disposed in an inclined state, and a liquid suction device of the same.

An inkjet type recording apparatus ejects minute ink drops from nozzles of the recording head to the media so as to print desired pictures, such as letters or figures.

A kind of inkjet type recording apparatus has a head disposed in an inclined state. An example of this kind of inkjet type recording apparatus is a large-format printer. For example, longitudinal paper from a paper roll is transported to the inclined head, which prints on the paper. An inkjet type recording apparatus having such an inclined head is disclosed (for example, JP-A-2003-237092 (Pages 6 to 7, FIG. 4)).

In the inkjet type recording apparatus disclosed in JP-A-2003-237092, however, the head is disposed in an inclined state, and as a result, a cap, which is provided to seal (cover) nozzles of the head and to suction ink, seals a nozzle plate surface of the head in an inclined state. For this reason, problems occur, for example, as shown in FIG. 13.

FIG. 13 is a view illustrating a related inclined head 1050 and a related inclined cap 1060. The cap 1060 seals a nozzle plate surface 1000 of the head 1050. An absorption material 1025 is housed in the cap 1060. The cap 1060 is provided with only an ink suction port which is connected to a suction pump, at the lower portion thereof.

On the other hand, a plurality of nozzles 1020 are formed at the nozzle plate surface 1000. The nozzles 1020 are arranged from an upper portion 1051 to a lower portion 1052 of the head 1050 in series at regular intervals. Ink 1070 is supplied through a reservoir 1026 from an ink cartridge (not shown) side to each nozzle 1020. There is a head pressure difference H between the nozzle 1020 at the upper portion 1051 and the nozzle 1020 at the lower portion 1052. When the suction pump, which is not shown, is operated while the nozzles 1020 are sealed by the cap 1060, the pressure inside the cap 1060 is decreased, and therefore, ink from each nozzle 1020 is suctioned into the cap 1060.

The ink which is flowed out from the nozzles 1020 flows downward along the nozzle plate surface 1000. At this time, an air layer 1071 in the cap 1060 is exhausted through the ink suction port 1001. As indicated by oblique lines, ink 1072 is filled between the nozzle 1020 at the lower portion 1052 of the head 1050 and the ink suction port 1001.

In this state, the pressure in the vicinity of the nozzle 1020 at the lower portion 1052 is lower than the pressure of the air layer 1071. Specifically, the suction pressure applied to the nozzles 1020 at the lower portion 1052 side is greater than the suction pressure applied to the nozzles 1020 at the upper portion 1051 side.

For this reason, when the ink flows in the absorption material 1025, fluid resistance of the ink is generated. Consequently, the distance from the ink suction port 1001 to the air layer 1071 is greater than the distance from the ink suction port 1001 to the nozzle 1020 at the lower portion 1052, and therefore, the pressure of the nozzles 1020 at the lower portion 1052 side is lower than the pressure of the nozzles 1020 at the upper portion 1051 side in the air layer 1071.

Since the nozzles 1020 at the upper portion 1051 side and the nozzles 1020 at the lower portion 1052 side are not horizontally disposed, the suction pressure is higher at the nozzles 1020 at the lower portion 1052 side than at the nozzles 1020 at the upper portion 1051 side. In other words, ink is flowed out from the nozzles 1020 at the lower portion 1052 side even when low suction pressure is applied.

Furthermore, in this state, since the air layer 1071 is not exhausted while following wrong path, when the suctioning operation is continuously performed, the pressure inside the cap 1060 is lowered, the flow F2 of the ink generated by the pressure difference is faster than the flow F1 of the ink supplied from the ink cartridge. Therefore, the air layer 1071 flows backward into the head 1050 from the nozzles 1020 at the lower portion 1051 side.

As a result, air is introduced into the nozzles 1020 at the upper portion 1051 side of the head 1050, and after that, when the cap 1060 is removed, and ink is ejected from the nozzles 1020 of the head 1050, for example, air is also ejected from several nozzles 1020 at the upper portion 1051 side. Consequently, the ink is not appropriately ejected. For example, dot omission occurs.

### SUMMARY

It is therefore an object of the present invention to provide a liquid ejecting apparatus that is capable of accurately drawing or printing pictures, while preventing dot omission even when the suctioning operation is performed to a head disposed in an inclined state, and a liquid suction device of the same.

In order to achieve the object, according to the invention, there is provided a liquid ejecting apparatus operable to eject liquid onto a medium, the liquid ejecting apparatus comprising:

a head, inclined with respect to a horizontal line, and including nozzles from which the liquid is ejected to the medium; and

a liquid suction device, including
a main body, operable to seal the nozzles,
a suction unit, operable to suction the interior of the main body so as to suction the liquid from the nozzles,
a first suction port, provided at an upper portion of the main body, and connected to the suction unit, and
a second suction port, provided at a lower portion of the main body, and connected to the suction unit.

With this configuration, the main body of the liquid suction device is provided to seal the nozzles. The suction unit suctions the interior of the main body, such that the interior of the main body is in a negative pressure state, to suction the liquid from the nozzles.

The first suction port is provided at the upper portion of the main body such that the first suction port is connected to the suction unit, and the second suction port is provided at the lower portion of the main body such that the second suction port is connected to the suction unit.

Consequently, when the interior of the main body is suctioned by the suction unit, such that the main body is in the negative pressure state, while the nozzles are sealed by the main body, it is possible for the suction unit to suction the liquid in the main body and the air in the main body from the first suction port disposed at the upper portion of the main body and the second suction port disposed at the lower portion of the main body. As a result, in the case that the ink is suctioned, it is possible to suction simultaneously from the upper portion side of the main body and the lower portion side of the main body, and therefore, no pressure difference occurs between the nozzles located at the upper side of the head and the nozzles located at the lower side of the head. Consequently, introduction of air into nozzles located at the upper side of the head is prevented. For this reason, even when the head, which is disposed in the inclined state, is suctioned, so-called dot omission is prevented, and therefore, accurate picture drawing or printing is accomplished.

The liquid suction device may include a first tube that is connected to the first suction port and the suction device and a second tube that is connected to the second port and the suction unit.

In this case, the liquid suction device includes the first tube and the second tube, such that the liquid in the main body can be suctioned from both the first suction port and the second suction port by the suction unit, when the liquid in the main body is suctioned. The first tube connects the first suction port and the suction unit. The second tube connects the second suction port and the suction unit.

Consequently, the liquid and the air can be reliably ejected out of the main body through the first suction port and the second suction port by using the first tube and the second tube.

The first tube may be provided with a valve that allows the first tube to be opened to an atmosphere.

In this case, the valve is provided on the first tube for allowing the first tube to be opened to the atmosphere from the state in which the first tube is connected to the suction unit, when the suction unit suctions the liquid remaining in the main body from the second suction port while the first suction port is opened to the atmosphere.

Consequently, when the first tube is opened to the atmosphere, from the state in which the first tube is connected to the suction unit, by the valve, it is possible to reliably perform the vacuum suctioning operation to the liquid remaining in the main body.

The first suction port may be greater than the second suction port, and the first tube may be greater than the second tube in section.

The first suction port may be equal to the second suction port in size, and the first tube may be equal to the second tube in section.

In this case, the size of the first suction port is equal to or greater than that of the second suction port. Furthermore, the flow channel size of the first tube is equal to or greater than that of the second tube.

Consequently, the resistances at the time of suctioning by the suction unit may be equal at the upper and lower portions of the main body. Alternatively, the sizes of the first suction port and the first tube corresponding to the uppermost nozzle may be set greater than those of the second suction port and the second tube, in consideration of the head difference between the uppermost nozzle of the head and the lowermost nozzle of the head, whereby the resistance at the time of suctioning of the first suction port and the first tube is less than that at the time of suctioning of the second suction port and the second tube. As a result, it is possible to smoothly eject the liquid and the air out of the main body.

A plurality of the first suction port may be provided at the upper portion of the main body, and a plurality of the second suction port may be provided the lower portion of the main body.

In this case, the plurality of first suction ports are provided at the upper portion of the main body, and the plurality of second suction ports are provided at the lower portion of the main body.

Consequently, it is possible to more efficiently eject the liquid and the air out of the main body through the first suction ports and the second suction ports.

According to the invention, there is also provided a liquid suction device, provided in a liquid ejecting apparatus operable to eject liquid onto a medium from nozzles of a head inclined with respect to a horizontal line, the liquid suction device comprising:

a main body, operable to seal the nozzles,

a suction unit, operable to suction the inside of the main body so as to suction the liquid from the nozzles,

a first suction port, provided at an upper portion of the main body, and connected to the suction unit, and

a second suction port, provided at a lower portion of the main body, and connected to the suction unit.

Consequently, when the interior of the main body is suctioned by the suction unit, such that the main body is in the negative pressure state, while the nozzles are sealed by the main body, it is possible for the suction unit to suction the liquid in the main body and the air in the main body from the first suction port disposed at the upper portion of the main body and the second suction port disposed at the lower portion of the main body. As a result, in the case that the ink is suctioned, it is possible to suction simultaneously from the upper portion side of the main body and the lower portion side of the main body, and therefore, no pressure difference occurs between the nozzles located at the upper side of the head and the nozzles located at the lower side of the head. Consequently, introduction of air into nozzles located at the upper side of the head is prevented. For this reason, even when the head, which is disposed in the inclined state, is suctioned, so-called dot omission is prevented, and therefore, accurate picture drawing or printing is accomplished.

### BRIEF DESCRIPTION OF THE DRAWINGS

FIG. 1 is a side view illustrating an inkjet type recording apparatus, which is an embodiment of a liquid ejecting apparatus according to the present invention.

FIG. 2 is a view illustrating the structure of the inkjet type recording apparatus of FIG. 1 at the home position side thereof.

FIG. 3 is a block diagram illustrating an example of an electrical connection of the inkjet type recording apparatus.

FIG. 4 is a view illustrating an example of a shape of a nozzle plate surface and ink cartridges.

FIG. 5 is a view illustrating an example of nozzles, a reservoir, and an ink cartridge.

FIG. 6 is a view illustrating a main body of an ink suction device separated from the nozzle plate surface.

FIG. 7 is a detailed view illustrating the structure of the main body and other components of FIG. 6.

FIG. 8 is a view illustrating the nozzle plate surface sealed by the main body of FIG. 7.

FIG. 9 is a perspective view illustrating a main body according to the embodiment of the present invention.

FIG. 10 is a view illustrating the suction performed by the main body according to the embodiment of the present invention.

FIG. 11 is a perspective view illustrating a main body according to another embodiment of the present invention.

FIG. 12 is a perspective view illustrating a main body according to yet another embodiment of the present invention.

FIG. 13 is a view illustrating the suctioning operation performed by the related cap.

### DETAIL DESCRIPTION OF PREFERRED EMBODIMENTS

Now, embodiments of the present invention will be described in detail with reference to the accompanying drawings.

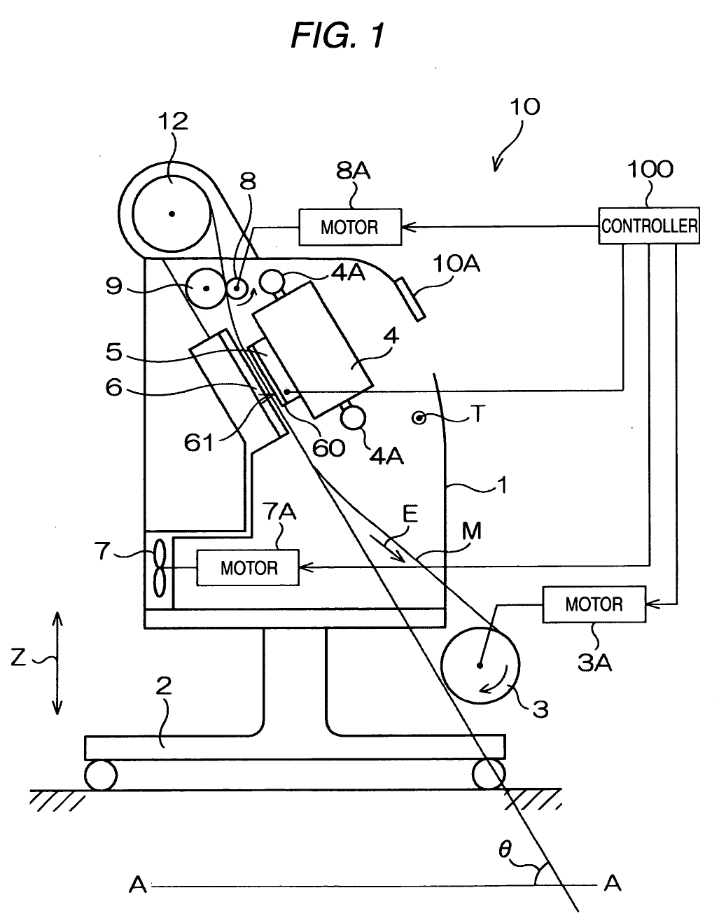

The liquid ejecting apparatus 10 shown in FIG. 1 is, for example, an inkjet type recording apparatus, such as an inkjet type large-format printer.

The liquid ejecting apparatus 10 includes a body part 1, a supporting part 2, a winder 3, a carriage 4, a recording head 5, a platen 6, a suction fan 7, feed rollers 8 and 9, an operation panel 10A, and a controller 100.

The carriage 4, the platen 6, the feed rollers 8 and 9, and the suction fan 7 are housed in the body part 1. The recording head 5 is fixed to the carriage 4. The carriage 4 and the recording head 5 are disposed at an oblique angle θ to line A-A, which is a horizontal line. The oblique angle θ is, for example, 60 degrees. The carriage 4 can perform scanning in the direction perpendicular to the paper surface of FIG. 1, i.e., in a main scanning direction T, together with the recording head 5. The recording head 5 includes a nozzle plate 60, and a nozzle plate surface 61 of the nozzle plate is opposed to the platen 6. Also, the platen 6 is disposed at an oblique angle e to the line A-A.

Recording paper M is formed in a roll 12, and is detachably attached to the top of the body part 1. The recording paper M from the roll 12 passes between the feed rollers 8 and 9, passes between the platen 6 and the nozzle plate surface 61, and is wound by the winder 3.

The recording paper M is fed in a direction E by the feed rollers 8 and 9, and is wound by the winder 3. For example, the feed roller 8 is rotated by a motor 8A, and the winder 3 is rotated by a motor 3A.

When the recording paper M passes between the recording head 5 and the platen 6, the carriage 4 performs scanning in the main scanning direction T Consequently, pictures are drawn or printed on the recording paper M, for example, in colors. The controller 100 controls the supply of drive voltage to a piezoelectric oscillator of the recording head 5 such that liquid is ejected from the nozzles, and controls the motors 8A and 3A. Also, the controller 100 controls a motor 7A such that the suction fan 7 can be rotated by the motor 7A. As the suction fan 7 is rotated, the recording paper is suctioned to the platen 6.

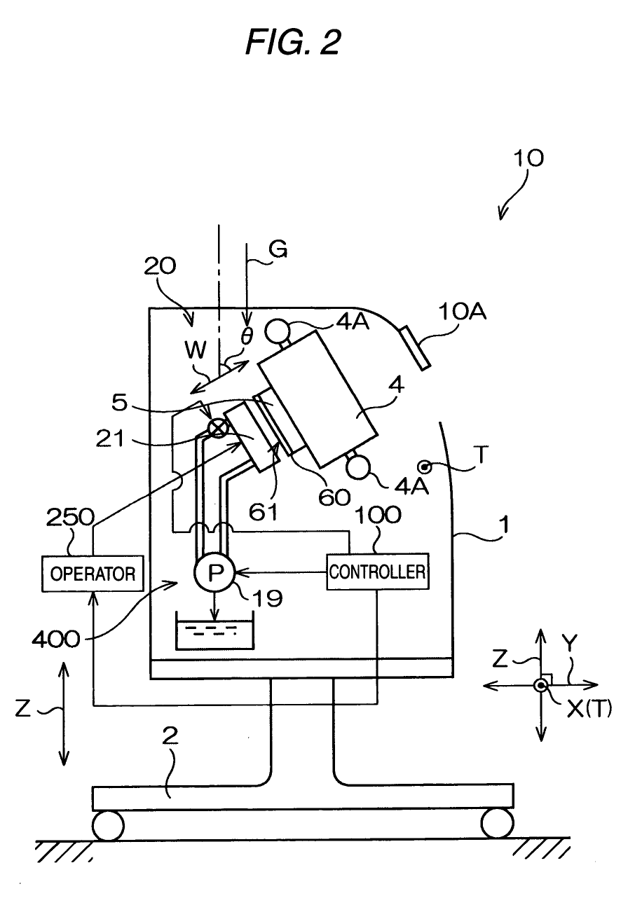

In FIG. 2, when the carriage 4 and the recording head 5 are moved in the main scanning direction T with the result that the carriage 4 and the recording head 5 are separated from the position where the carriage 4 and the recording head 5 are opposed to the platen 6, and the carriage 4 and the recording head 5 are opposed to the ink suction device 20. The ink suction device 20 is an example of liquid suction device. The ink suction device 20 is housed in the body part 1. The ink suction device 20 is located at a home position G, which is out of the picture drawing or printing area of the recording paper M.

The recording head 5 shown in FIGS. 1 and 2 is an example of inkjet type liquid ejecting head. Also, the recording head 5 is referred to as a print head.

The carriage 4 shown in FIGS. 1 and 2 can perform scanning in the main scanning direction T by guide rails 4A and 4A.

The ink suction device 20 located at the home position G as shown in FIG. 2 may be referred to as a capping system or a capping device. The nozzle plate surface 61 of the recording head 5 located at the home position G is opposed to the main body 21 of the ink suction device 20. The main body 21 may be referred to as a cap. The nozzle plate surface 61 is an example of the nozzle surface.

The ink suction device 20 shown in FIG. 2 has a suction unit 400. The ink suction device 20 serves to prevent ink from being dried at nozzle openings of the recording head 5 and to apply the negative pressure from a suction pump 19 to the nozzle openings such that the ink from the nozzle opening is forcibly suctioned and thus ejected. The suction pump 19 is one of the components constituting the ink suction device 20. The ink is an example of liquid.

In addition, as shown in FIG. 4, a wiping member 400W is disposed at the side of the ink suction device 20. When the suctioning operation is performed to the nozzle plate surface 61 of the recording head 5, the wiping member 400W wipes off the ink attached to the nozzle plate surface 61.

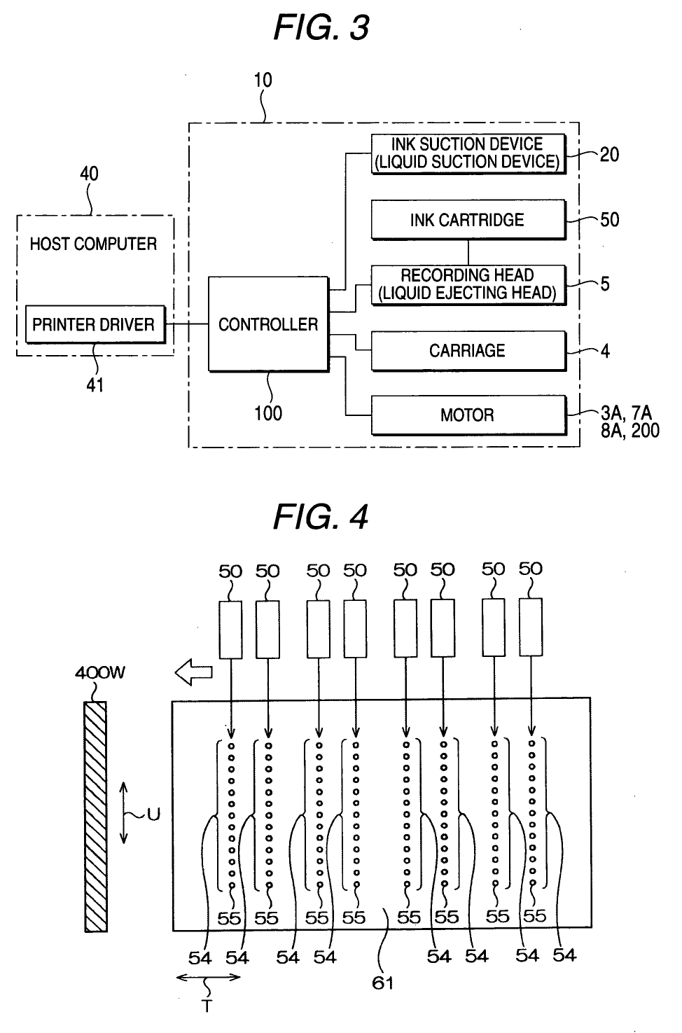

As shown in FIG. 3, the controller 100 of the inkjet type recording apparatus 10 is connected to a printer driver 41 of a host computer 40 via a local printer cable or a communication network. The printer driver 41 includes software for transmitting commands to perform a printing or cleaning operation or an ink suctioning operation to the inkjet type recording apparatus 10.

The liquid ejecting apparatus 10 shown in FIG. 3 includes the ink suction device 20, ink cartridges 50, the recording head 5, the carriage 4, and the motors 3A, 8A, and 7A, in addition to the controller 100.

Meanwhile, the direction perpendicular to the paper surface of FIG. 2 is the main scanning direction T, which is the same as the X direction. The Y direction is the lateral direction of FIG. 2, which is the horizontal direction. The Z direction is the vertical direction. The X direction, the Y direction, and the Z direction are at right angles to each other.

As shown in FIG. 4, each nozzle opening array 54 ejects the same kind of ink or different kinds of ink. The “different kinds of ink” refers to not only the difference between colors in appearance but also the difference in kinds and ratios of components of the ink. Each nozzle opening array 54 includes, for example, several tens to several thousands of nozzles 55.

As shown in FIG. 4, the nozzle opening array 54 are arranged in parallel with each other at regular intervals in the main scanning direction T. For example, the number of the nozzle opening array 54 is eight. The longitudinal direction of each nozzle opening array is the U direction.

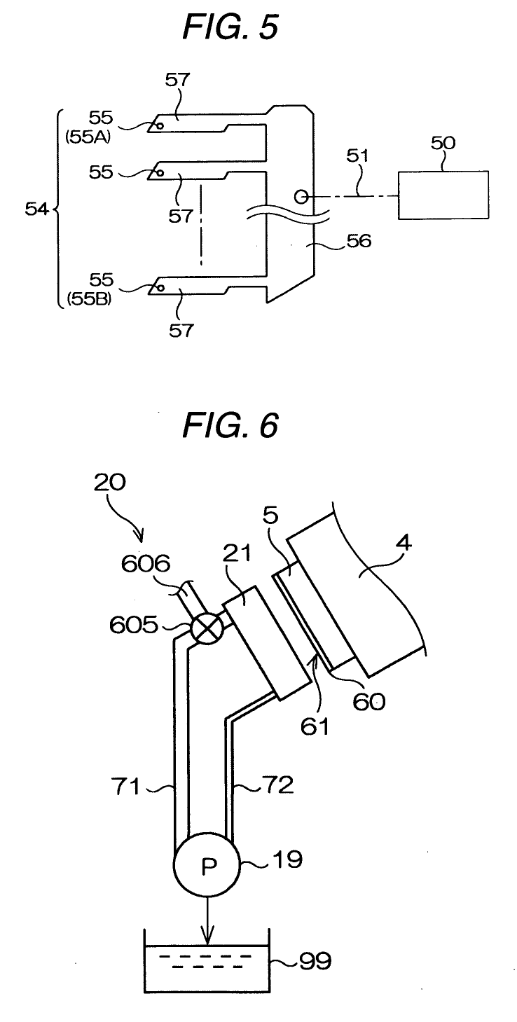

As shown in FIG. 5, a reservoir (common ink chamber) 56 is connected to an ink cartridge 50 via an ink passageway 51 and a plurality of nozzles 55. The nozzles 55 constitute each nozzle opening array 54 shown in FIG. 4. Each nozzle 55 is connected to the reservoir 56 via a pressure chamber 57.

For a more clear understanding, the uppermost nozzle is indicated by reference numeral 55A, and the lowermost nozzle is indicated by reference numeral 55B.

FIG. 6 is an enlarged view of the ink suction device 20 shown in FIG. 2.

The ink suction device 20 shown in FIG. 6 includes a main body 21, a first tube 71, a second tube 72, a suction pump 19, a switching valve 605, an atmosphere opening 606, and a waste liquid tank 99. The main body 21 is opposed to the nozzle plate surface 61. The main body 21 seals the respective nozzles of the nozzle plate surface 61.

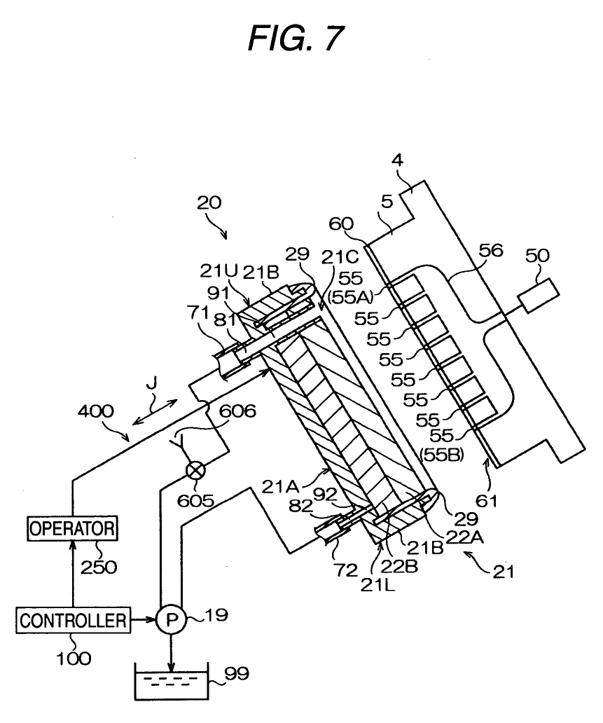

As shown in FIG. 7, the ink cartridges 50 are connected to the recording head 5 such that the ink cartridges 50 correspond to the eight nozzle opening array, respectively. Specifically, the ink cartridges 50 are located while being separated from the recording head 5. Consequently, the liquid ejecting apparatus shown in FIG. 1 is a so-called off-carriage type inkjet printer.

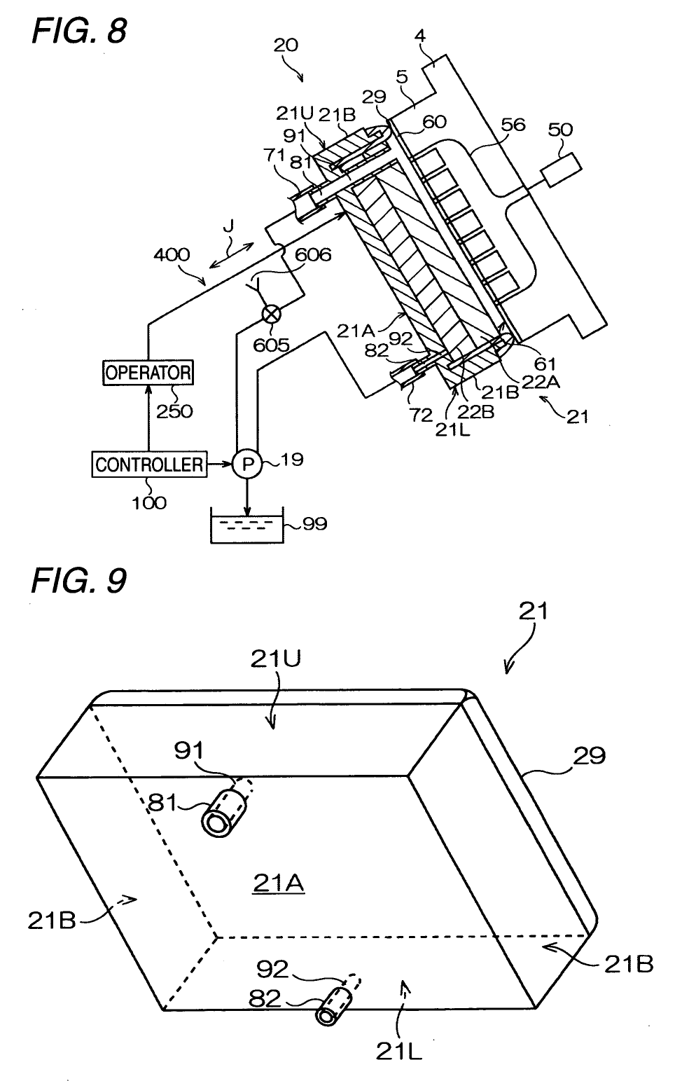

In FIGS. 6 and 7, the main body 21 of the ink suction device 20 is separated from the nozzle plate surface 61. In FIG. 8, on the other hand, the nozzle plate surface 61 is sealed by the main body 21.

As shown in FIG. 7, the main body 21 of the ink suction device 20, which is made of metal or plastic, has a bottom part 21A and four side parts 21B. At an upper part of the main body 21 is formed an opening 21C. The size of the opening 21C is slightly less than that of the nozzle plate surface 61. Consequently, as shown in FIG. 8, the nozzle plate surface 61 is sealed while all the nozzles 55 of the nozzle plate surface 61 are surrounded by the opening 21C.

Absorption materials 22A and 22B are arranged in the main body 21 in a stacked structure. It is preferable that the absorption materials 22A and 22B absorb ink from the recording head 5. For example, sponge made from poly vinyl alcohol (PVA), which is foamed plastic, may be used as the absorption materials 22A and 22B. The absorption materials may be arranged in a three-layered structure, not in a two-layered structure. Alternatively, the absorption materials may be arranged in a single-layered structure.

The main body 21 of FIG. 7 has a first connection pipe 81 and a second connection pipe 82. As shown in FIG. 9, the first connection pipe 81 is mounted at the upper portion 21U side of the main body 21 such that the first connection pipe 81 protrudes from the bottom part 21A approximately at the middle of the bottom part 21A in the lateral direction of the bottom part 21A (in the direction perpendicular to the paper surface of FIG. 7). Similarly, the second connection pipe 82 is mounted at the lower portion 21L side of the main body 21. The second connection pipe 82 protrudes from the bottom part 21A approximately at the middle of the bottom part 21A in the lateral direction of the bottom part 21A (in the direction perpendicular to the paper surface of FIG. 7). As shown in FIG. 7, the first connection pipe 81 is connected to a first suction port 91. As shown in FIG. 7, the second connection pipe 82 is connected to a second suction port 92.

As shown in FIG. 7, the first suction port 91 communicates with the opening 21C side, preferably, via the absorption materials 22A and 22B.

It is characterized that, as shown in FIGS-7 and 9, the flow channel size of the first connection pipe 81 is set greater than that of the second connection pipe 82. Furthermore, the inner diameter of the first suction port 91 is set greater than that of the second suction port 92.

The first connection pipe 81 is detachably connected to one end of the first tube 71. The second connection pipe 82 is detachably connected to one end of the second tube 72. The first tube 71 and the second tube 72 are made of, for example, flexible plastic. The flow channel size of the first tube 71 is set greater than that of the second tube 72.

Consequently, the resistances at the time of suctioning by the ink suction device 20 may be equal at the upper and lower position of the main body 21. Alternatively, the sizes of the first suction port 91 and the first tube 71 corresponding to the uppermost nozzle 55A may be set greater than those of the second suction port 92 and the second tube 72, in consideration of the head difference between the uppermost nozzle 55A of the recording head 5 and the lowermost nozzle 55B of the recording head 5, whereby the resistance at the time of suctioning of the first suction port and the first tube is less than that at the time of suctioning of the second suction port and the second tube. As a result, it is possible to smoothly eject the liquid and the air out of the main body.

The other end of the first tube 71 and the other end of the second tube 72 are both connected to the suction pump 19.

The suction unit 400 is connected to the main body 21. The suction unit 400 includes the first tube 71, the second tube 72, the suction pump 19, the atmosphere opening 606, and the switching valve 605.

The switching valve 605 is switched by a command from the controller 100 shown in FIG. 1 such that the first tube 71 is connected to the atmosphere opening 606 in the middle thereof or the first tube 71 is not connected to the atmosphere opening 606. When the switching valve 605 is switched to the atmosphere opening 606, the atmosphere opening 606 is connected to the first suction port 91 via the first tube 71 and the first connection pipe 81. Consequently, the pressure inside the main body 21 can be restored from the negative pressure state to the atmosphere pressure state.

An operator 250, which shown in FIG. 7, is a mechanism that is capable of enabling the main body 21 to perform the linear reciprocating movement in the J direction such that the main body 21 is moved from the separated state as shown in FIG. 7 into the sealed state as shown in FIG. 8. The operator 250 may be constructed, for example, in the combination of a feed screw, a motor, and a nut, by which the main body 21 can be separated from the nozzle plate surface 61 as shown in FIG. 7, or can be brought into tight contact with the nozzle plate surface 61 and thus sealed as shown in FIG. 8.

Now, the suctioning operation (cleaning operation) performed by the liquid suction device 20 of the liquid ejecting apparatus 10 with the above-mentioned construction will be described.

The main body 21 is brought into tight contact with the nozzle plate surface 61 as shown in FIG. 8 from the state in which the main body 21 is separated from the nozzle plate surface 61 as shown in FIG. 7. In this case, since the main body 21 has a tight contact member 29, which is elastically deformable, and the respective nozzles 55 of the nozzle plate surface 61 are sealed by the tight contact member 29.

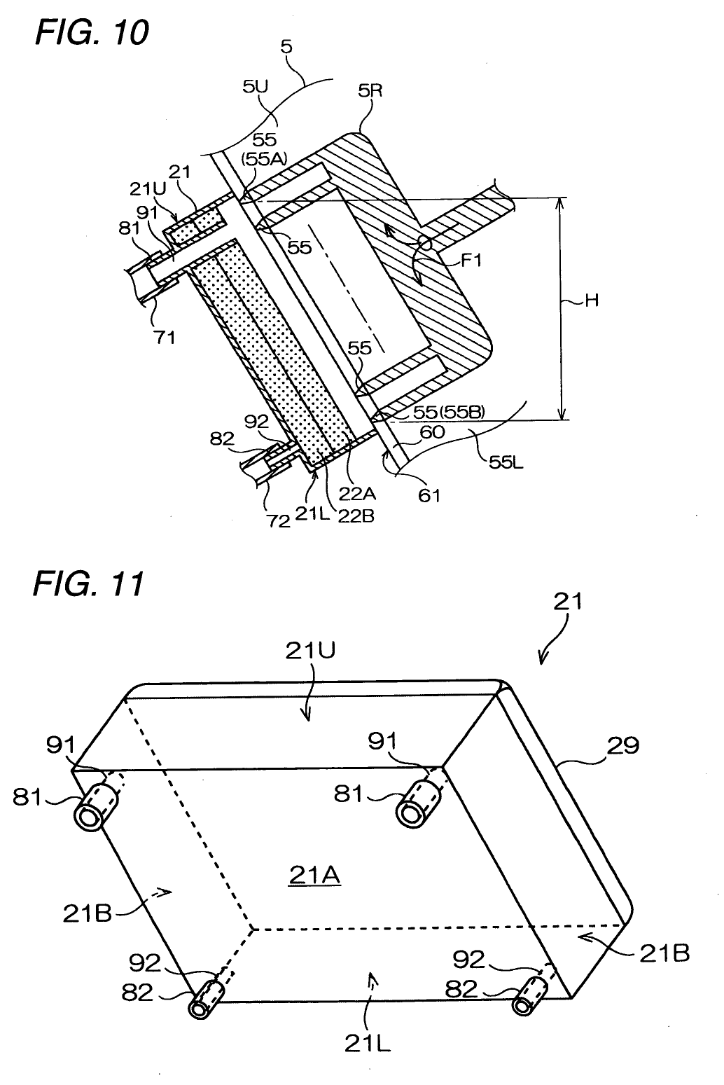

Referring to FIG. 8, when the suction pump 10 is operated, ink is suctioned into the main body from the respective nozzles 55. Specifically, as shown in FIGS. 8 and 10, the suction pump 19 can suction, and at the same time, eject ink and air in the main body 21 from the first suction port 91 and the second suction port 92 through the first tube 71 and the second tube 72.

As a result, it is possible to suction the ink in the main body 21 approximately uniformly through the nozzle 55A at the upper portion 5U side and the nozzle 55b at the lower portion 5L side of the recording head 5. Consequently, unlike the related art, the air in the main body 32 is prevented from being introduced to the reservoir 56 side of the recording head 5 from the nozzle 55A at the upper portion 5U side. For example, when the nozzle 55A at the upper portion 5U side and the nozzles 55 in the vicinity of the nozzle 55A eject ink, ejection of air is prevented, i.e., dot omission of the ink is prevented. Consequently, when the recording head 5 ejects ink to draw or print pictures, the quality of the pictures is improved.

Next, when the ink in the main body 21 is ejected by vacuum suctioning, the switching valve 605 shown in FIG. 8 is switched such that the atmosphere opening is connected to the first suction port 91 side. As a result, the suctioning force of the suction pump 19 is not applied to the first suction port 91 side from the first tube 71. The suctioning force of the suction pump 19 suctions the interior of the main body 21 from the second suction port 92 through the second tube 72.

At the time of vacuum suctioning, the first suction port 91, which is disposed at the upper side, is not used. The liquid in the main body 21 is ejected into the waste liquid tank 99 only through the second suction port 92, which is disposed at the lower side, by the vacuum suctioning. As described above, the inner diameter of the flow channel of the first tube 71 shown in FIG. 10 is greater than that of the flow channel of the second tube 72, and the inner diameter of the flow channel of the first connection pipe 81 is greater than that of the flow channel of the second connection pipe 82. As a result, the first suction port 91 is set greater than the second suction port 92.

Consequently, the resistance at the upper side suction system extending from the suction pump 19 to the first suction port 91 via the first tube 71 is set less than that at the lower side suction system extending from the suction pump 19 to the second suction port 92 via the second tube 72. This setting is performed in consideration of the head pressure difference H between the uppermost nozzle 55A and the lowermost nozzle 55B as shown in FIG. 10. Consequently, it is possible to smoothly and reliably eject the liquid and the air in the main body 21, at the same time, from the upper side auctioning system and the lower side auctioning system into the waste liquid tank 99.

### OTHER EMBODIMENTS OF THE PRESENT INVENTION

In the embodiment of FIG. 11, two first connection pipes 81 and 81 are mounted at the upper portion 21U side of the main body 21. The first connection pipes 81 are connected to first suction ports 91, respectively. The first connection pipes 81 and the first suction ports 91 are provided at the upper corners of the bottom part 21A of the main body 21. On the other hand, two second connection pipes 82 protrude from the lower side of the bottom part 21A of the main body 21. The second connection pipes 82 are connected to second suction ports 92, respectively.

In the embodiment of FIG. 11, the flow channel size of each of the first connection pipes 81 is greater than that of each of the second connection pipes 82, and the size of each of the first suction ports 91 is greater than that of each of the second suction ports 92.

In this way, pluralities of first connection pipes 81 and first suction ports 91 and pluralities of second connection pipes 82 and second suction ports 92 may be provided. The respective first connection pipes 81 are connected to the suction pump 19 via the first tube 71 shown in FIG. 7. The two second connection pipes 82 are connected to the suction pump 19 via the second tube 72 shown in FIG. 7. An opening valve 605 is provided at the first tube 71.

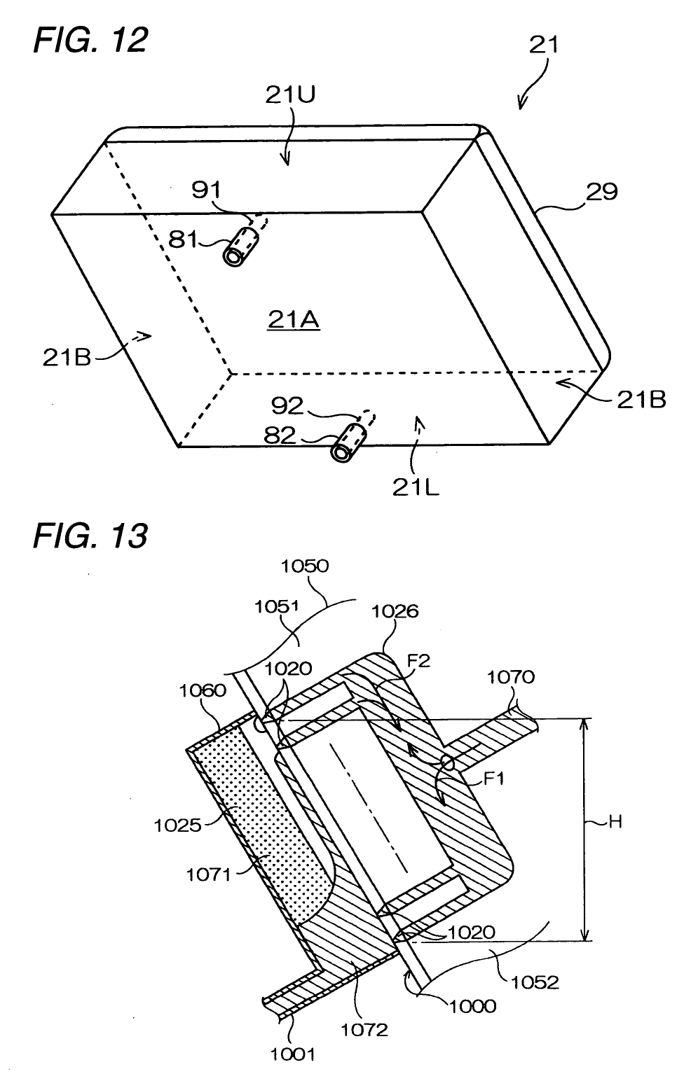

The embodiment of FIG. 12 is different from the embodiment of FIG. 9 in that the flow channel size of the first connection pipe 81 is equal to that of the second connection pipe 82, and the size of the first suction port 91 is equal to that of the second suction port 92. In this way, the first connection pipe 81 and the first suction port 91 at the upper portion 21U side may have the same sizes as the second connection pipe 82 and the second suction port 92 at the lower portion 21L side.

According to an embodiment of the present invention, when the interior of the main body is suctioned by the suction unit, such that the main body is in the negative pressure state, while the nozzles are sealed by the main body, it is possible for the suction unit to suction the liquid in the main body and the air in the main body from the first suction port disposed at the upper portion of the main body and the second suction port disposed at the lower portion of the main body. As a result, in the case that the ink is suctioned, it is possible to suction simultaneously from the upper portion side of the main body and the lower portion side of the main body, and therefore, no pressure difference occurs between the nozzles located at the upper side of the head and the nozzles located at the lower side of the head. Consequently, introduction of air into nozzles located at the upper side of the head is prevented For this reason, even when the head, which is disposed in the inclined state, is suctioned, so-called dot omission is prevented, and therefore, accurate picture drawing or printing is accomplished.

According to another embodiment of the present invention, the liquid and the air can be reliably ejected out of the main body through the first suction port and the second suction port by using the first tube and the second tube. When the first tube is opened to the atmosphere, from the state in which the first tube is connected to the suction unit, by the switching valve, it is possible to reliably perform the vacuum suctioning operation to the liquid remaining in the main body. The resistances at the time of suctioning by the suction unit may be equal at the upper and lower portion of the main body. Alternatively, the sizes of the first suction port and the first tube corresponding to the uppermost nozzle may be set greater than those of the second suction port and the second tube, in consideration of the head difference between the uppermost nozzle of the head and the lowermost nozzle of the head, whereby the resistance at the time of suctioning of the first suction port and the first tube is less than that at the time of suctioning of the second suction port and the second tube. As a result, it is possible to smoothly eject the liquid and the air out of the main body.

According to yet another embodiment of the present invention, pluralities of first suction ports and second suction ports are provided, and therefore, it is possible to more efficiently eject the liquid and the air out of the main body.

In the embodiments of the present invention, paper is referred to as an example of the media M. However, the media M of the present invention is not limited to the paper For example, other kinds of recording media may be used without limits.

The present invention is not limited to the inkjet type recording apparatus, For example, the present invention can also be applied to a liquid ejecting apparatus using a liquid ejecting head for ejecting liquid, such as a recording head used in picture recording apparatuses, for example, printers, a color material ejecting head used for manufacturing color filters of liquid crystal displays, an electrode material ejecting head used for forming electrodes of organic light emitting displays or field emission displays (FED), and a bio organic matter ejecting head used for manufacturing biochips, and to a sample ejecting apparatus used as a precision pipette.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

In the above-described embodiments of the present invention, the structure may be partially omitted or modified.

What is claimed is:

1. A liquid ejecting apparatus operable to eject liquid onto a medium, the liquid ejecting apparatus comprising:
a head, inclined with respect to a horizontal line, and including nozzles from which the liquid is ejected to the medium; and
a liquid suction device, including
a main body, operable to seal the nozzles,
a suction unit, operable to suction the interior of the main body so as to suction the liquid from the nozzles,
a first suction port, provided at an upper portion of the main body, and connected to the suction unit, and
a second suction port, provided at a lower portion of the main body, and connected to the suction unit.

2. The liquid ejecting apparatus according to claim 1, wherein
the liquid suction device includes a first tube that is connected to the first suction port and the suction device and a second tube that is connected to the second port and the suction unit.

3. The liquid ejecting apparatus according to claim 2, wherein
the first tube is provided with a valve that allows the first tube to be opened to an atmosphere.

4. The liquid ejecting apparatus according to claim 2, wherein
the first suction port is greater than the second suction port, and the first tube is greater than the second tube in section.

5. The liquid ejecting apparatus according to claim 2, wherein
the first suction port is equal to the second suction port in size, and
the first tube is equal to the second tube in section.

6. The liquid ejecting apparatus according to claim 1, wherein
a plurality of the first suction port are provided at the upper portion of the main body, and
a plurality of the second suction port are provided the lower portion of the main body.

7. A liquid suction device, provided in a liquid ejecting apparatus operable to eject liquid onto a medium from nozzles of a head inclined with respect to a horizontal line, the liquid suction device comprising:
a main body, operable to seal the nozzles,
a suction unit, operable to suction the inside of the main body so as to suction the liquid from the nozzles,
a first suction port, provided at an upper portion of the main body, and connected to the suction unit, and
a second suction port, provided at a lower portion of the main body, and connected to the suction unit.
